(19) United States
(12) Patent Application Publication
(10) Pub. No.: US 2010/0012280 A1
(43) Pub. Date: Jan. 21, 2010

(54) FOLDING DOOR ASSEMBLY

(75) Inventors: Eric Hans, Mission Viejo, CA (US); Berhard Riek, Mainhardt (DE)

Correspondence Address: KNOBBE MARTENS OLSON & BEAR LLP, 2040 MAIN STREET, FOURTEENTH FLOOR, IRVINE, CA, 92614, US

(73) Assignee: John B. Higman and Valorie J. Higman; Trustees of the Higman Family Trust u/d/t as amended and resta, Brea, CA (US)

(21) Appl. No.: 12/522,909

(22) PCT Filed: Jan. 11, 2008
(86) PCT No.: PCT/US08/50928

§ 371 Date: Jul. 10, 2009

Related U.S. Application Data
(60) Provisional application No. 60/880,255, filed on Jan. 12, 2007.

(51) Int. Cl. E05D 15/26; E05D 7/04

(52) U.S. Cl. 160/211; 16/247; 160/405

(57) ABSTRACT

A folding door system can include adjustable pivotal joints. Hinge-type pivotal joints can include one or more adjustable spacers to allow the relative positions of hinges and door panels to be easily varied. The pivotal joints, and included adjustable spacers, can be surface mounted to reinforcing cladding strips spanning substantially an entire height of a door panel. This surface mount facilitates access to the pivotal joints for rapid adjustment, removal, or installation of a door panel in a door system.

### CROSS REFERENCE TO RELATED APPLICATION

This application claims the benefit of U.S. Provisional Patent Application No. 60/880,255, entitled “FOLDING DOOR ASSEMBLY,” filed on Jan. 12, 2007.

Also, this application hereby incorporates by reference the above-identified provisional application, in its entirety.

### BACKGROUND OF THE INVENTION

1. Field of the Invention

This application relates generally to folding door assemblies and more specifically to bi-fold or multi-fold door systems.

2. Description of the Related Art

Various multi-panel folding door systems have been used to provide access to relatively large door openings. In a typical “bi-fold” door system, adjacent panels are hinged relative to one another and, when the door is opened, fold accordion-style. This accordion-style folding allows the door system to span a relatively large door opening without protruding significantly farther than one door panel-width into a room when the door is opened.

Folding door systems are often used in locations where it is desirable to preserve one's view. Therefore, framed glass door panels including a wood frame and a glass insert are frequently used in conjunction with a folding door system. These door panels are often quite heavy, placing high loads on hardware connecting the door panels. Over repeated usage cycles, the hardware can distort, leading to a misalignment of door panels. Additionally, the wood frames of individual door panels can expand and contract under varying temperature and humidity conditions, also resulting in misalignment of the door panels. This misalignment can lead to premature wear of hinges, rollers, and other door components, difficulty to operate the doors, and drafts or leaking between adjacent door panels or a door panel and the door jamb.

Attempts to reduce the incidence of hardware distortion have been made by cladding a wood frame with metal segments to reinforce the door panels at critical locations. However, even with clad doors, misalignment persists due to expansion and contraction of the individual door panels. Moreover, clad doors often have door hardware obscured by the cladding such that to adjust the door hardware, install a door system, or replace an individual door panel requires considerable disassembly and reassembly.

### SUMMARY OF THE INVENTION

The present application discloses various embodiments of a folding door system that offer certain advantages in view of the above-noted shortcomings of the prior art. In certain embodiments, the door systems disclosed herein can include an adjustable spacer to facilitate door panel adjustment. In other embodiments, the door systems can have easily accessible cladding, hinges, and/or other connection hardware to facilitate installation, adjustment, and repair.

In certain embodiments, a folding door system comprises a first door panel, a second door panel, a cladding strip, a pivotal joint, and an adjustable spacer. The first door panel has a first edge and a second edge. The second door panel has a first edge and a second edge. The cladding strip spans substantially all of the first edge of the first door panel. The pivotal joint pivotally couples the first door panel at the first edge of the first door panel to the second door panel at the first edge of the second door panel. The adjustable spacer has a first configuration in which the pivotal joint is a first distance from the cladding strip and a second configuration in which the pivotal joint is a second distance from the cladding strip.

In other embodiments, a folding door system comprises a first door panel, a second door panel, a cladding strip, and a pivotal joint. The first door panel has a first edge and a second edge. The second door panel has a first edge and a second edge. The cladding strip spans substantially all of the first edge of the first door panel. The pivotal joint pivotally couples the first door panel at the first edge of the first door panel to the second door panel at the first edge of the second door panel. The pivotal joint is accessibly mounted to the cladding strip.

The folding door system according to any of the embodiments described herein may comprise one or more cladding strips, portions, or sections (collectively, strips). In one embodiment, the cladding strip spans substantially all of the first edge of the second door panel. The pivotal joint, in some embodiments, may pivotally couple the cladding strip of the first door panel to the cladding strip of the second door panel. In one embodiment, the first door panel comprises a recess at the first edge of the first door panel. The cladding strip may be positioned in the recess. In other embodiments, the second door panel comprises a recess at the first edge of the second door panel, with a cladding strip of positioned in the recess of the second door panel. In one embodiment, the invention comprises a third door panel. Additional door panels may also be included.

In some embodiments, the cladding strip comprises an aluminum material. Other materials may also be used, as described below. In one embodiment, the cladding strip comprises an aluminum extrusion.

In several embodiments, the invention comprises a folding door system includes one or more pivotal joints. The pivotal joint may comprise one or more hinges. In one embodiment, the pivotal joint comprises three hinges. In another embodiment, the pivotal joint further comprises a carriage configured to translate in a door jamb.

In some embodiments of the invention, a three door panel is provided. In one embodiment, the third door panel is pivotally connected to one of the first door panel and the second door panel.

In one embodiment, a first door panel and a second door panel are connected or otherwise coupled to a door jamb defining a door opening. The connection comprises a pivotal connection at least one pivotal joint and at least one spacer defining the position of the pivotal joint relative the first door panel or the second door panel. When the adjustable spacer is in the first position, the first distance is approximately one millimeter, but in some embodiments can be adapted to range from about 0.1 mm to about 5 mm. When the spacer is in the second position, the second distance is approximately two millimeters, but in some embodiments can be adapted to range from about 0.1 mm to about 5 mm.

Door systems described herein include multi-fold doors, such as bi-fold doors. Doors may be provided as two doors that fold to one side. Alternatively, doors may be provided as four doors, with two doors that fold to each side. In other embodiments, doors may be provided as six, eight, ten or more doors. For example, in a six door embodiment, two doors may fold to one side and four doors to the other side.

In some embodiments, the invention comprises a hinge system that is adapted for use in the door systems described herein, or for other applications. In one embodiment, the hinge system for pivotally connecting a first door panel to an adjacent second door panel in a folding door assembly comprises a first housing, a second housing, a hinge pin, and an adjustable spacer. Each of the first housing and the second housing have a mounting portion and a generally cylindrical portion defining a passage. The mounting portion of the first housing is configured to be mounted to the first door panel. The mounting portion of the second housing is configured to be mounted to the second door panel. The hinge pin is sized and configured to pass through the passages defined by the cylindrical portions of the first housing and the second housing. The hinge pin has a longitudinal axis defining an axis of rotation of the first housing with respect to the second housing. The adjustable spacer is positioned between one of the first housing and the first door panel, and the second housing and the second door panel. The adjustable spacer is configured to provide an offset therebetween. The adjustable spacer has a first mounted orientation in which the offset is a first distance, and a second mounted orientation in which the offset is a second distance.

In some embodiments of hinge system, the hinge system can further comprise a second adjustable spacer positioned between the other of the first housing and the first door panel, and the second housing and the second door panel. The second adjustable spacer is configured to provide an offset therebetween.

In some embodiments of hinge system, the hinge system can further comprise a first mount plate and a second mount plate. The first mount plate is for mounting the first housing to the first door panel. The second mount plate is for mounting the second housing to the second door panel.

In some embodiments of hinge system, the hinge system can further comprise a carriage and a third housing. The third housing is pivotally coupled to the first and second housings by the hinge pin. The third housing is pivotally coupled to the carriage by a carriage hinge pin such that the carriage can pivot about an axis spaced apart from the axis of rotation of the first and second housings.

In several embodiments of the invention, a method of manufacturing a folding door system is provided. In one embodiment, the method comprises providing a first door panel and a second door panel; and connecting the first door panel to the second door panel such that a first edge of the first door panel can pivot with respect to a first edge of the second door panel. Connecting the first and second door panels comprises mounting a first pivotal joint housing to the first edge of the first door panel; mounting a second pivotal joint housing to the first edge of the second door panel; and mounting an adjustable spacer at least partially defining an offset distance between the first pivotal joint housing and the first edge of the first door panel.

In some embodiments of the method of manufacture, connecting the first and second door panels further comprises mounting an adjustable spacer at least partially defining an offset distance between the second pivotal joint housing and the first edge of the second door panel. In some embodiments of the method of manufacture, the first and second pivotal joint housings are pivotally connected with respect to each other. In some embodiments of the method of manufacture, connecting the first and second door panels further comprises pivotally connecting the first and second pivotal joint housings with respect to each other. In some embodiments, the method manufacture further comprises mounting a cladding strip to the first edge of the first door panel. In some embodiments, mounting the cladding strip comprises forming a recess in the first edge of the first door panel and mounting the cladding strip in the recess.

### BRIEF DESCRIPTION OF THE DRAWINGS

The figures disclosed herein are representative of certain embodiments of the invention. Figures may be combined to illustrate a single embodiment. Alternatively, items illustrated in one figure may be used in embodiments depicted in alternate figures.

FIG. 1 illustrates a schematic perspective view of one embodiment of folding door system having three door panels;

FIG. 2 illustrates a front elevational view of a pivotal connection of two of the door panels of the door system of FIG. 1;

FIG. 3 illustrates a cross-sectional top view of the pivotal connection of FIG. 2;

FIG. 4 illustrates an exploded perspective view of one pivotal joint of the pivotal connection of FIG. 2;

FIG. 5a illustrates a top view of a portion of the pivotal joint of FIG. 4 at a first spacing from a door panel in the door system of FIG. 1;

FIG. 5b illustrates a top view of a portion of the pivotal joint of FIG. 4 at a second spacing from a door panel in the door system of FIG. 1;

FIG. 5c illustrates a top view of a portion of the pivotal joint of FIG. 4 at a third spacing from a door panel in the door system of FIG. 1;

FIG. 6 illustrates a front elevational view of a pivotal connection of two adjacent door panels of the door system of FIG. 1;

FIG. 7a illustrates an exploded perspective view of an upper pivotal joint of the pivotal connection of FIG. 6;

FIG. 7b illustrates an exploded perspective view of a lower pivotal joint of the pivotal connection of FIG. 6

FIG. 8 illustrates a front view of a pivotal connection of one of the door panels with a door jamb in the door system of FIG. 1;

FIG. 9 illustrates a cross-sectional top view of the pivotal connection of FIG. 8;

FIG. 10 illustrates an embodiment of folding door system having two door panels;

FIG. 11 illustrates an embodiment of folding door system having three door panels;

FIG. 12a illustrates an embodiment of folding door system having four door panels;

FIG. 12b illustrates an embodiment of folding door system having four door panels;

FIG. 12c illustrates an embodiment of folding door system having four door panels;

FIG. 13a illustrates an embodiment of folding door system having five door panels;

FIG. 13b illustrates an embodiment of folding door system having five door panels;

FIG. 13c illustrates an embodiment of folding door system having five door panels;

FIG. 14a illustrates an embodiment of folding door system having six door panels;

FIG. 14b illustrates an embodiment of folding door system having six door panels;

FIG. 14c illustrates an embodiment of folding door system having six door panels;

FIG. 14d illustrates an embodiment of folding door system having six door panels;

FIG. 15a illustrates an embodiment of folding door system having seven door panels;

FIG. 15b illustrates an embodiment of folding door system having seven door panels;

FIG. 15c illustrates an embodiment of folding door system having seven door panels;

FIG. 15d illustrates an embodiment of folding door system having seven door panels;

FIG. 16a illustrates an embodiment of folding door system having eight door panels;

FIG. 16b illustrates an embodiment of folding door system having eight door panels;

FIG. 16c illustrates an embodiment of folding door system having eight door panels;

FIG. 16d illustrates an embodiment of folding door system having eight door panels; and

FIG. 16e illustrates an embodiment of folding door system having eight door panels.

### DETAILED DESCRIPTION OF THE PREFERRED EMBODIMENT

Several embodiments of folding door systems and accessories, including connection and attachment devices are described herein. In some embodiments, the door systems comprise one or more adjustable spacers to facilitate door panel adjustment. In other embodiments, the door systems comprise cladding, hinges, and other connection hardware that are readily accessible for installation, adjustment, and repair.

### Three Panel Folding Door System

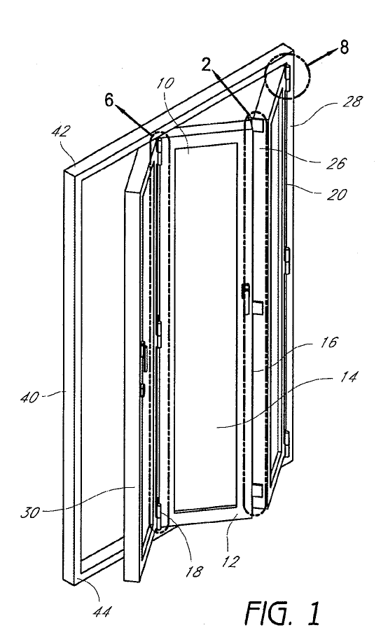

FIG. 1 illustrates an exemplary folding door system having three panels 10, 20, 30. The first door panel 10 can have a frame 12 surrounding a glass panel 14. As illustrated, both the frame 12 and the glass panel 14 are generally rectangular, but it is contemplated that in other embodiments, the frame and glass panel could have different shapes, included but not limited to square, round, oval, etc. Moreover, in other embodiments, a door panel could comprise more than one glass panel. The first door panel 10 has a first edge 16 and a second edge 18.

In the illustrated embodiment, a second door panel 20 likewise having a first edge 26 and a second edge 28 is pivotally connected to the first door panel 10 such that the first edge 16 of the first door panel 10 can rotate with respect to the first edge 26 of the second door panel 20. As illustrated, the second door panel 20 has a framed glass structure similar to that of the first door panel 10. However, it is recognized that in other embodiments, the second door panel 20 could be solid (without glass window portion), or have a different style of framed glass panel than the first door panel 10.

With continued reference to FIG. 1, the door system includes a third door panel 30 that is pivotally coupled to the first door panel 10 at the second edge 18 of the first door panel 10. The third door panel 30 has substantially similar framed glass construction as the first and second door panels 10, 20. However, it is recognized that different structures could be used for the various panels.

Although the glass panel in any of the panels preferably comprises glass, other transparent or translucent materials may also be used, including but not limited to acrylic and vinyl. The first, second, and/or third door panels may be solid or comprise opaque inserts. In one embodiment, more than 3 panels are used. The panels may comprise, for example, wood, metal, vinyl, or a combination thereof. In one embodiment, the first, second, and/or third door panels have a height in the range of about 4′ about 24′, preferably about 6′ to about 8′. The width of each door panel is in the range of about 0.5° to about 8′, preferably about 1′ to about 4′. The thickness is in the range of about 0.1″ to about 10″, preferably about 1″ to about 3″. Smaller or larger sizes may also be used. In some embodiments, the folding door system comprises 2, 4, 8, 12, or 16 door units. A folding door panel system can span a door jamb of varying widths from approximately 1′ to 35′, and preferably 3′ to 24′. The door panels may be identical or different to each another with respect to shape, dimensions, and construction.

The door system of FIG. 1 is disposed in a door jamb 40 having a header 42 and a sill 44. During installation according to one embodiment, the sill 44 is disposed on or slightly offset from a building floor, and the header 42 can be offset from a building ceiling by a span of wall. Various sill 44 and header 42 configurations can be used with the door systems described herein to provide desired sealing properties, load bearing properties, and desired aesthetic characteristics.

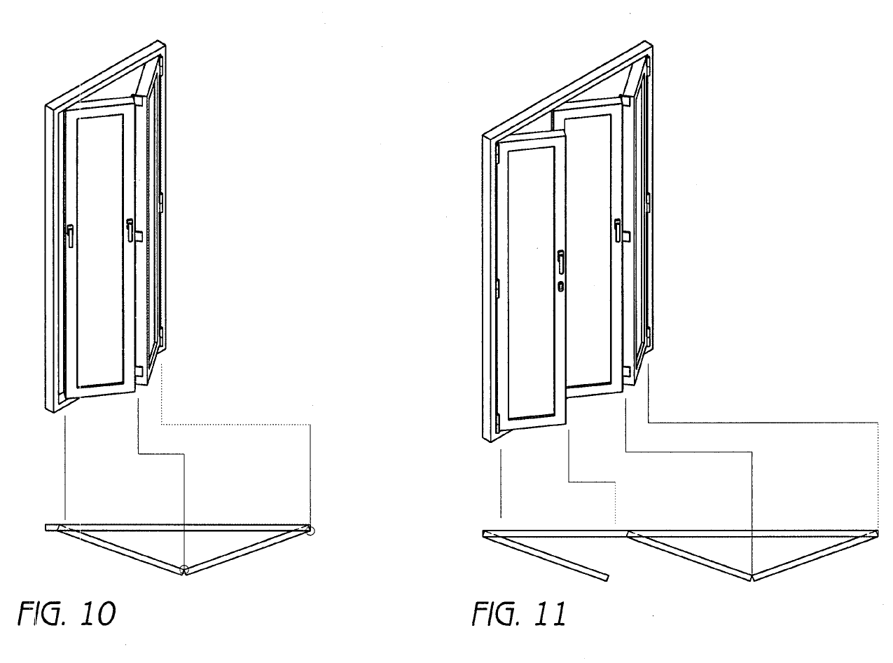

In the door system embodiment illustrated in FIG. 1, the second edge 28 of the second door panel 20 is pivotally connected to the door jamb 40. The first edge 26 of the second door panel 20 is pivotally connected to the first edge 16 of the first door panel 10. The second edge 18 of the first door panel 10 is pivotally connected to the third door panel 30. The third door panel 30 can include a latch to selectively connect to the door jamb. Thus, an initial opening is formed when the latched connection is released and the third door panel 30 is slid towards the second door panel. As further discussed below in FIGS. 10-16, in other embodiments, a latched connection, and thus an initial opening can be positioned at different locations on the door system such as between two adjacent door panels.

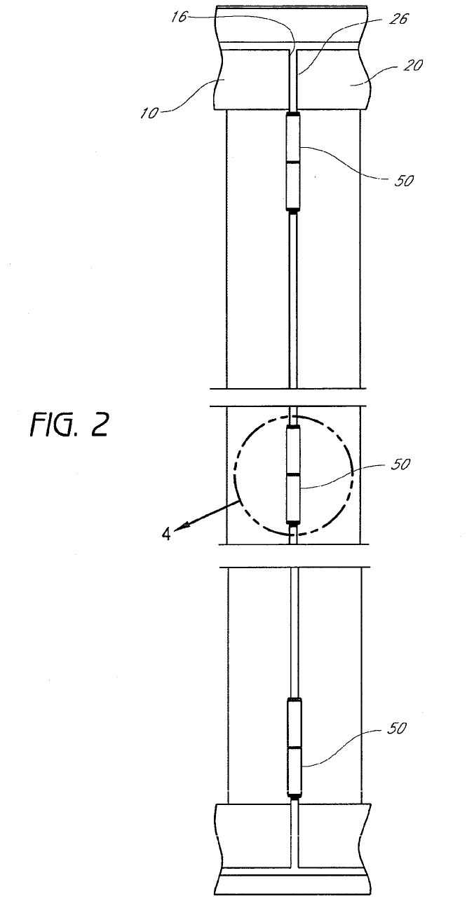

The illustrated door system has a closed position in which the three door panels 10, 20, 30 are substantially co-planar and occupy substantially the entire door jamb 40 opening. The door system has an open position in which the door panels 10, 20, 30 each define offset substantially parallel planes. FIG. 1 illustrates the door system in a partially opened position in which the three door panels 10, 20, 30 define transverse planes. As illustrated, during an opening movement, the pivotal connection of the first door panel 10, and the second door panel 20 is moved away from the door jamb 40 and the pivotal connection of the first door panel 10 and the third door panel 30 moves along the door jamb. Thus, during the illustrated opening operation, the second edge 18 of the first door panel 10 is translated along the sill 44 and header 42 towards the second edge 28 of the second door panel. The pivotal joints that accomplish this opening motion are discussed below with reference to FIGS. 2-9.

### Door Panel-to-Door Panel Pivotal Connection

FIG. 2 illustrates a front view of the pivotal connection between the first edge 16 of the first door panel 10 and the first edge 26 of the second door panel 20. As illustrated, the door system is in a closed configuration where the adjacent door panels 10, 20 are substantially coplanar. As illustrated, three pivotal joints 50 connect the first door panel 10 to the second door panel. As described in further detail below, the pivotal joints can allow the first edge 16 of the first door panel 10 to rotate with respect to the first edge 26 of the second door panel 20. The pivotal joints 50 can be roughly evenly distributed along the first edges 16, 26 such that one pivotal joint 50 is connected near an upper end of the first edges 16, 26, one is connected approximately at a midpoint of each of the first edges 16, 26, and one is connected near a lower end of the first edges 16, 26. In other embodiments, more or fewer than three pivotal joints can be used in a pivotal connection. Additionally, in other embodiments, the pivotal joints 50 can be arranged such that they are not evenly distributed. For example, where a door panel has a high weight concentration in an upper or lower half such as where a heavy glass panel, (e.g., a multicolored, or stained glass panel) is positioned at an upper portion of a door panel, multiple hinges can be located in close proximity to the weight concentration.

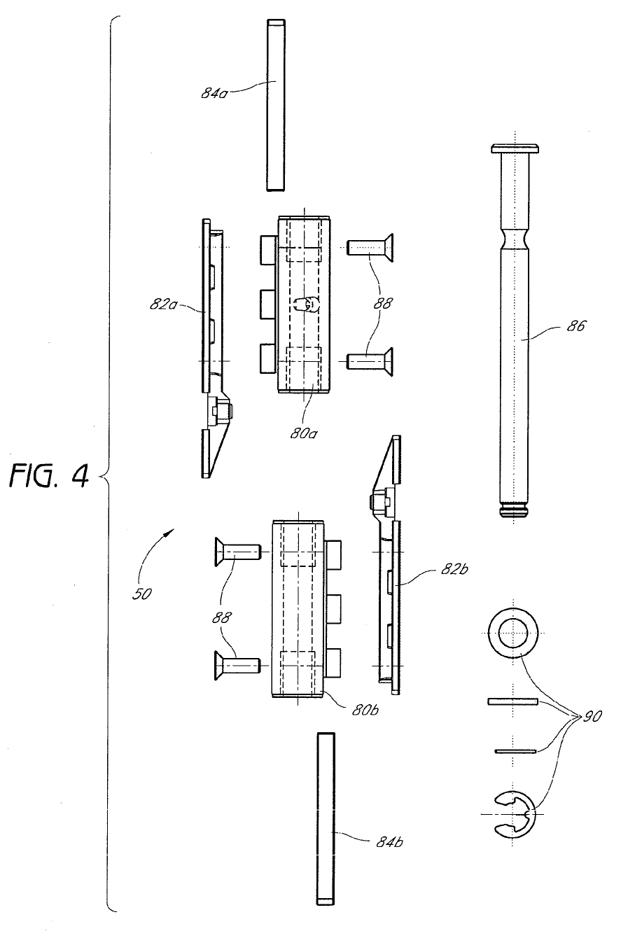

As further discussed below with respect to FIG. 4, the pivotal joints 50 can comprise hinges having a pair of housings, each housing configured to be mounted to a corresponding door panel 10, 20. Each housing defines a generally cylindrical passage. The cylindrical passages of the two housings are aligned to form a hinged connection. An axle or hinge pin can be positioned though the passages of the aligned housings. The hinge pin defines an axis of rotation of the pivotal joint 50. In other embodiments, different types of pivotal connectors can be used to form the pivotal connection between door panels.

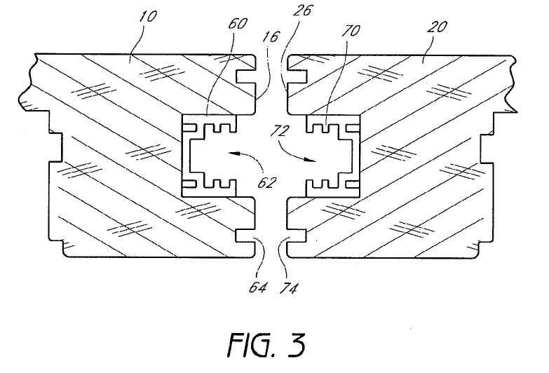

FIG. 3 illustrates a top cross-sectional view of the pivotal connection between the first door panel 10 and the second door panel 20. As illustrated in FIG. 3, the door panels 10, 20 are in a closed configuration such that the panels are substantially coplanar.

In the illustrated embodiment, the first door panel 10 comprises a recess 62 at the first edge 16. As illustrated, the second door panel 20 likewise comprises a recess 72 at the first edge 26. The recesses 62, 72 each have a generally rectangular cross-sectional profile. The recesses 62, 72 each span substantially the entire first edge 16, 26 of the corresponding door panel 10, 20. In other embodiments, the recesses 62, 72 can have a different cross-sectional profile, or can extend varying lengths along the first edges.

With continued reference to FIG. 3, in the illustrated embodiment, a cladding strip 60, 70 is disposed in each of the recesses 62, 72. The cladding strips 60, 70 desirably extend along substantially the entire length of the first edges 16, 26 of the door panels 10, 20. Advantageously, cladding strips that extend along substantially the entire edge of a door panel can resist warping of a door panel and distortion of door hardware. Cladding strips 60, 70 extending substantially the entire length of the first edges 16, 26 can also strengthen the door assembly to allow a relatively larger glass area and smaller frame area, thus enhancing views through the door system. In other embodiments, it can be desirable to have cladding strips of shorter lengths to meet cost requirements, hardware packaging and alignment requirements or other desired properties of the door system.

An outer surface of the cladding strips 60, 70 desirably is generally u-shaped and configured to fit within the recesses 62, 72 in the door panels 10, 20. In some embodiments, the cladding strips can be directly mounted to the recesses 62, 72 of the door panels 10, 20 with fasteners such as screws. When mounted, the fasteners can then be accessible when the door system is in an opened configuration, allowing for rapid, easy removal of a door panel 10, 20 from a cladding strip 60, 70. Thus, individual door panels that become damaged can be rapidly replaced.

The cladding strips 60, 70 can have one or more reinforcing ribs formed therein to enhance the rigidity of the cladding strip. This enhanced rigidity can further reduce torquing of, and distortion of individual door panels through repeated usage cycles. As discussed below with respect to FIG. 4, the reinforcing rib can be configured to couple with a mount for the pivotal joint 50 (FIG. 2).

The cladding strips 60, 70 are desirably comprised of aluminum. Aluminum cladding strips can have desirable strength and rigidity properties as well as relatively light weight. Desirably, aluminum cladding strips can be formed by an extrusion process, thus consistently forming any reinforcing ribs along the length of the cladding strip 60, 70. In other embodiments, the cladding strips can comprise other metals, metal alloys, composites, or thermoplastics and are not necessarily formed by extrusion. For example, the cladding described herein may comprise copper, zinc, stainless steel, or a combination thereof. Claddings can also include sheet metal, liquid metal coatings, and natural metal composites.

With reference to FIG. 3, the first and second door panels 10, 20 can each include one or more weather stripping recess 64, 74. The weather stripping recesses 64, 74 can receive a segment of compressible weather stripping such as a natural or synthetic rubber weather striping. In the illustrated embodiment, each door panel 10, 20 includes a pair of weather stripping recesses 64, 74, one positioned near a front surface of the first edge 16, 26, and one positioned near a rear surface of the first edge 16, 26. Thus, each door panel 10, can have a corresponding pair of weather stripping pieces. When the door system is in a closed configuration, corresponding weather stripping pieces near the front and rear surfaces of the first edges 16, 26 form a seal. In other embodiments, different weather stripping configurations can be used. For example, in some embodiments, each door panel 10, 20 can include only a single weather stripping recess 64, 74 to retain a single weather stripping segment. In other embodiments, all the weather stripping segments can be retained by a single one of the door panels 10, 20. In still other embodiments, no weather stripping recesses 64, 74 are present and weather stripping segments can be adhered to the door panels 10, 20. In further embodiments, weather stripping segments are absent.

FIG. 4 illustrates an exploded view of a pivotal joint 50 as used in the pivotal connection of the first door panel 10 to the second door panel 20. The pivotal joint 50 comprises a first housing 80a and a second housing 80b. As noted above with respect to FIG. 2, the housings 80a, 80b can each include a generally cylindrical portion having a passage. The housings 80a, 80b can also include a mount portion comprising a generally flat surface configured to be mounted to a door panel 10, 20.

The pivotal joint 50 can also comprises a first mount plate 82a and a second mount plate 82b. The mount plates 82a, 82b can each be configured to couple with reinforcing ribs in the cladding strips 60, 70. The mount plates provide a reinforced surface to which the mount portion of the housings 80a, 80b can be mounted, thus distributing loads on the pivotal joints 50 over a relatively large area of the cladding strips 60, 70 (FIG. 3).

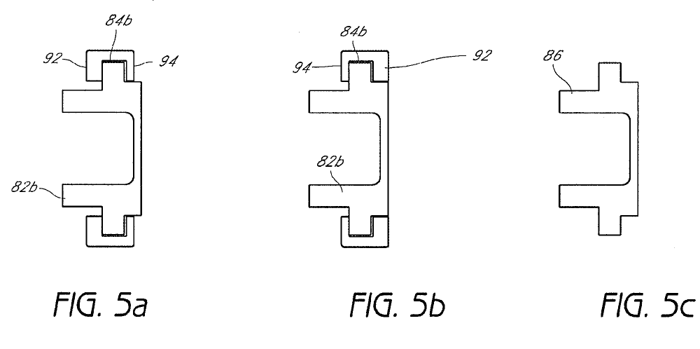

In some embodiments, the pivotal joint 50 can also comprise a first adjustable spacer 84a and a second adjustable spacer 84b. As discussed further with respect to FIGS. 5a-c, the adjustable spacers 84a, 84b are configured to provide adjustability between the position of the hinge housings 80a, 80b, and the cladding strips 60, 70. Desirably, this adjustability allows the position of one or more of the pivotal joints 50 to be easily adjusted with respect to the door panels 10, 20. Thus, should one or more of the door panels expand, contract, or distort, the door system can be easily reconfigured to prevent premature pivotal joint wear, binding during operation, or failure of the weather stripping to seal.

To assemble the pivotal joint 50, the housings 80a, 80b are arranged such that the passages of the generally cylindrical portions are substantially aligned, an axle or hinge pin 86 is inserted through the cylindrical portions and retained by hardware 90 such as washers and spring clips. In other embodiments, the hinge pin 86 can be press-fit into the housings 80a, 80b. In some embodiments, the adjustable spacers 84a, 84b are advanced over the mounting plates 82a, 82b, and the mounting plates 82a, 82b are positioned over mounting locations on the cladding strips 60, 70. The mounting portions of the housings 80a, 80b are positioned over the mounting plates 82a, 82b, and fasteners 88 such as bolts or screws are used to sandwich each of the housing 80a, 80b, the mounting plate 82a, 82b, and the adjustable spacer 84a, 84b. In the illustrated embodiment, the first housing 80a, first mounting plate 82a, and first adjustable spacer 84a are mounted to the cladding strip 60 of the first door panel 10. Likewise, the second housing 80b, second mounting plate 82b, and second adjustable spacer 84b are mounted to the cladding strip 70 of the second door panel 20. The hinge pin 86 has a longitudinal axis defining an axis of rotation of the pivotal joint 50. It is contemplated that in other embodiments, pivotal joints incorporating adjustable spacers can be directly mounted to edges of adjacent door panels without the use of cladding reinforcement.

As illustrated in FIGS. 5a-c, the adjustable spacers 84a, 84b are each configured to couple with the mounting plates 82a, 82b such that when oriented with a first surface 92 facing outward from the mounting plate 92a, 82b, the first surface 92 is a first distance from the mounting plate 82a, 82b (FIG. 5a), and when oriented with a second surface 94 facing outward from the mounting plate 82a, 82b, the second surface is a second distance from the mounting plate 82a, 82b (FIG. 5b). In still another arrangement, the pivotal joint can be assembled without an adjustable spacer 84a, 84b (FIG. 5c). When the pivotal joint 50 is assembled, the housing 80a, 80b rests on the outward-facing surface of the adjustable spacer 84a, 84b. In the illustrated embodiment, the second distance is smaller than the first distance. In one embodiment the first distance is approximately 2 millimeters and the second distance is approximately 1 millimeter such that the hinge housing 80a, 80b can be positioned either with no offset, approximately 1 mm of offset, or approximately 2 mm of offset from a cladding strip 60, 70. In other embodiments, adjustable spacers having different dimensions can be used in the disclosed door system. Furthermore, it is contemplated that different pivotal joints within a door system can have adjustable spacers of different sizes.

The amount of offset provided by the adjustable spacer 84a, 84b can be easily adjusted by removing the fasteners 88 connecting the pivotal joints 50 to the door panels 10, 20. Advantageously, according to one embodiment, the fasteners 88 are easily accessible with the door system in an open configuration. Therefore one or more pivotal joints on a pivotal connection can be easily adjusted to ensure smooth operation over a high number of opening cycles and various operating conditions.

### Door Panel-to-Door Panel-to-Door Jamb Pivotal Connection

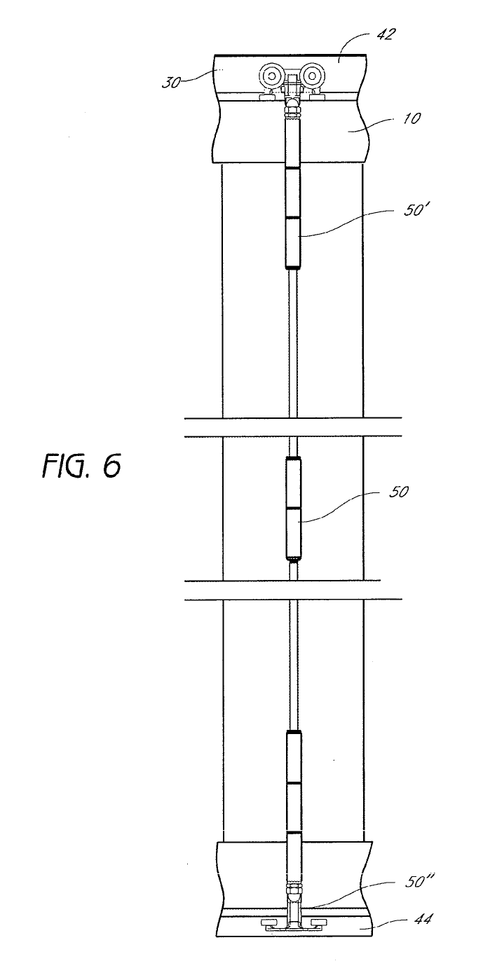

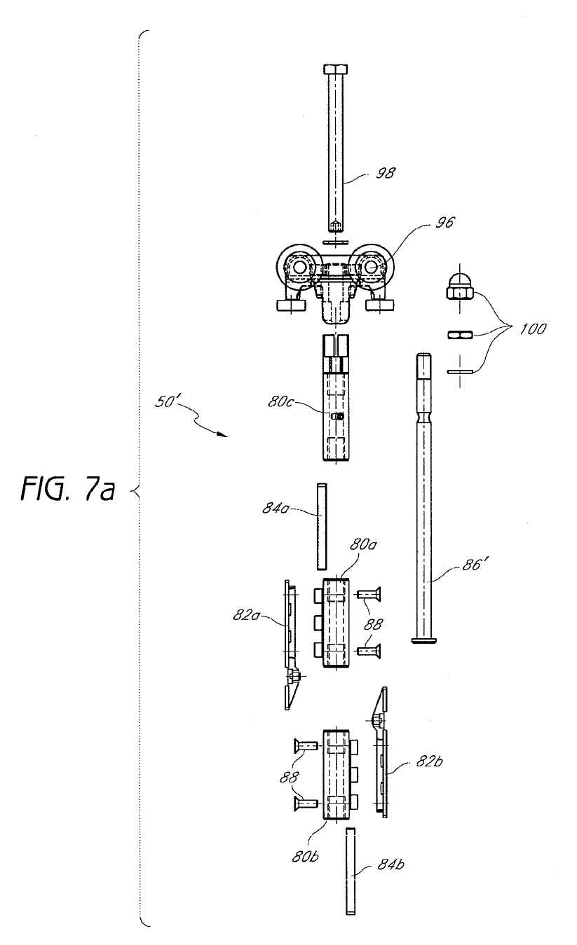

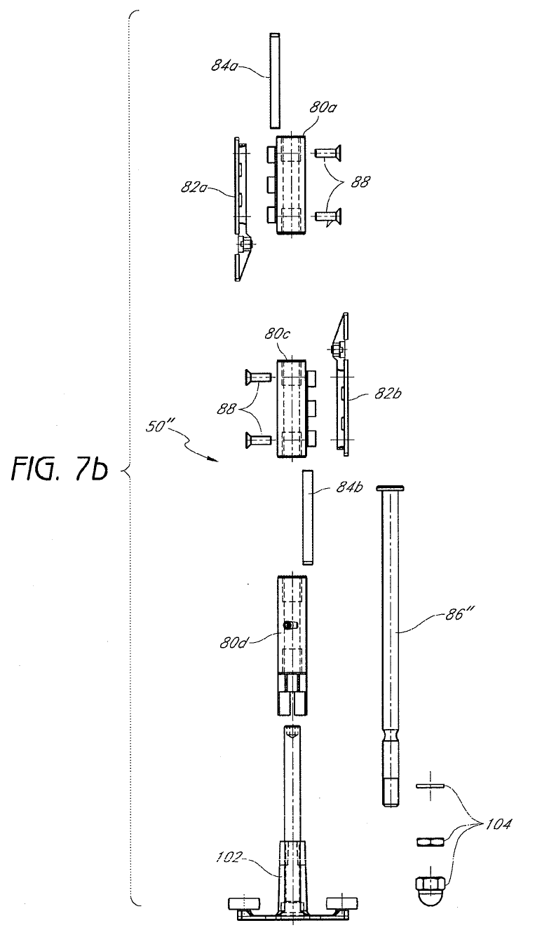

With reference to FIG. 6, one example of the pivotal connection between the first door panel 10 and the third door panel 30 is illustrated. As discussed above, the pivotal connection between the first door panel 10 and the third door panel 30 is configured to translate along the door jamb 40 as the door system opens and closes (FIG. 1). In the illustrated embodiment, the pivotal connection comprises an upper pivotal joint 50′, a lower pivotal joint 50″, and a center pivotal joint 50. The center pivotal joint 50 is substantially the same as described above with respect to FIG. 4. The upper and lower pivotal joints 50′, 50″ are described below with respect to FIGS. 7a and 7b. The meeting edges of the first and third door panels 10, 30 can desirably include cladding strips extending in recesses as described above with respect to the pivotal connection of the first and second door panels 10, 20 (FIG. 3).

As shown in FIG. 7a, the upper pivotal joint 50′ includes first and second housings 80a, 80b, first and second mounting plates 82a, 82b, and first and second spacers 84a, 84b as described above with respect to FIG. 4. Thus, the position of the upper pivotal joint 50′ is adjustable with respect to the door panels 10, 30. The upper pivotal joint 50′ further comprises an upper carriage 96 configured to provide smooth movement of the upper pivotal joint 50′ in the header 42 of the door jamb 40. In one embodiment, the upper carriage 96 can comprise rollers configured to roll in a track defined in the header of the door jamb.

In various embodiments, the door system can be configured such that the weight of the door system is primarily borne by the header 42 of the door jamb 40 while the sill 44 of the door jamb 40 acts primarily as a guide for the opening sequence of the door system. In other embodiments, a door system can be configured such that the weight of the door system is primarily borne by the sill 44 of the door jamb 40 while the header 42 acts primarily as a guide. In other embodiments, the weight of the door system can be borne by both the sill 44 and the header 42 of the door jamb 40. In the illustrated embodiment, the door system is configured such that the weight of the door system is borne by the header 42 of the door jamb 40, and the upper carriage 96 comprises rollers configured to bear the weight of the door system. The header 42 of the door jamb 40 can include a track adapted bear the weight of the door system and to receive the rollers of the upper carriage 96.

The upper pivotal joint 50′ further comprises a third housing 80c configured to pivotally couple the upper carriage 96 to the assembly of the first and second housings 80a, 80b. The third housing can define a pair of substantially parallel, but offset generally cylindrical passages. An axle such as a hinge pin 86′ passes through generally cylindrical passages in the first, second, and third housings 80a, 80b, 80c, and can be retained in the housings 80a, 80b, 80c with hardware 100 such as spring clips, washers, and other similar items. The hinge pin 86′ allows the first and third door panels 10, 30 to rotate with respect to one another. The hinge pin 86′ in the upper pivotal joint 50′ is relatively long compared to a hinge pin 86 in the middle pivotal joint as it must pass through three housings 80a, 80b, 80c. A second hinge pin 98 pivotally connects the carriage 96 to the third housing 80c through the second generally cylindrical passage of the third housing 80c such that the rollers of the carriage 96 can remain aligned with the header 42 while the third housing 80c rotates during opening or closing of the door system.

As shown in FIG. 7b, the lower pivotal joint 50″ has similar construction to the upper pivotal joint 50′ discussed above. The lower pivotal joint 50″ can comprise first and second housings 80a, 80b, first and second mounting plates 82a, 82b, first and second adjustable spacers 84a, 84b. A sandwiched assembly of the housings 80a, 80b, mounting plates 82a, 82b, and adjustable spacers 84a, 84b can be mounted to the door panels 10, 30 with fasteners 88 to allow the door panels 10, 30 to pivot relative to one another. As with the pivotal joints 50, 50′ discussed above, the position of the lower pivotal joint 50″ can be adjusted relative to the door panels 10, 30, by positioning of the adjustable spacers 84a, 84b.

The lower pivotal joint 50″ can further comprise a third housing 80d pivotally coupled to the first and second housings 80a, 80b by a hinge pin 86″ passing through generally cylindrical passages defined by the first housing 80a, the second housing 80b, and the third housing 80d. The hinge pin 86″ is relatively long with respect to the hinge pin 86 for a middle pivotal joint 50, discussed above. The hinge pin 86″ can be retained with hardware 104 such as washers, spring clips and nuts as described above.

The lower pivotal joint 50″ can further comprise a lower carriage 102. The lower carriage 102 is configured to travel along the sill 44 of the door jamb 40 when the door system is opening or closing. As discussed above, in the illustrated embodiment, the weight of the door system is substantially off of the sill 44. Therefore, the illustrated lower carriage 102 has rollers whose rolling surfaces are oriented such that they bear substantially no weight of the door system. Rather, the illustrated lower carriage 102 merely guides the door system during an opening or closing operation. In other embodiments, the lower carriage 102 can be configured to bear a portion of or substantially all of the weight of the door system. As illustrated, the lower carriage 102 is pivotally coupled to the third housing 80d with a hinge pin 106, such that the lower carriage 102 can maintain alignment relative to the sill 44 while the third housing 80d pivots during an opening or closing of the door system.

In some door system embodiments, it can be desirable to have a latched connection and an initial opening location between two adjacent door panels, such as, for example, in door system embodiments illustrated in FIGS. 11, 12c, 13b, 13c. In these embodiments upper and lower carriages 96, 102 similar to those of the upper and lower pivotal joints 50′, 50″ can be pivotally mounted to at least one of the adjacent door panels to be latchedly connected to maintain an edge of the at least one door panel in the door jamb 40 during opening and closing of the door systems.

### Door Panel-to-Door Jamb Pivotal Connection

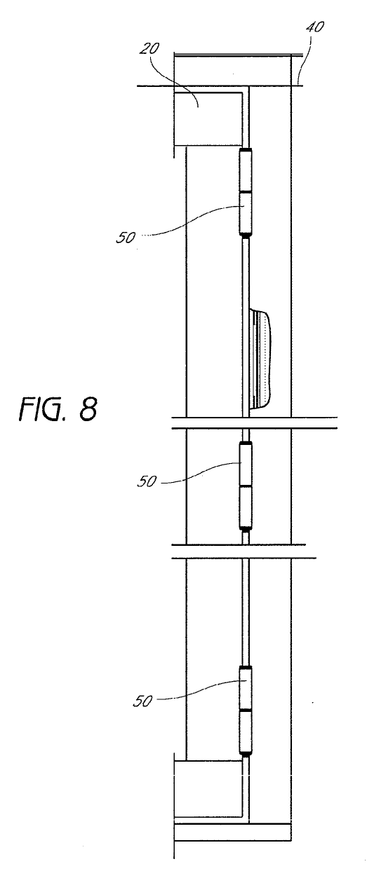

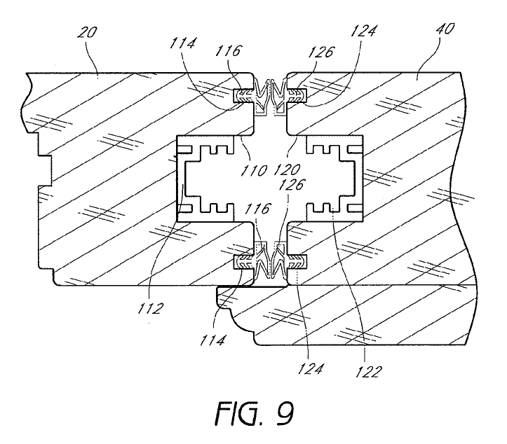

FIG. 8 illustrates a front view of a pivotal connection between the second door panel 20 and the door jamb 40. In the illustrated embodiment, three pivotal joints 50 substantially similar to those disused above with reference to FIGS. 2 and 4 pivotally connect the second end 28 (FIG. 9) of the second door panel 20 to the door jamb. The pivotal joints 50 can include adjustable spacers 84a, 84b (FIG. 4) to allow the position of the hinge to be easily adjusted relative to the second door panel 20 and the door jamb 40. As previously discussed, it is contemplated that in other embodiments, different numbers and arrangements of pivotal joints can be used to pivotally connect the second door panel 20 to the door jamb 40.

FIG. 9 illustrates a cross-sectional top view of the pivotal connection of the second door panel 20 to the door jamb 40. As illustrated in FIG. 9, the second door panel 20 and the door jamb 40 each have a recess 110, 120 in which a cladding strip 112, 122 is positioned. According to one embodiment, the cladding strip 112, 122 desirably extends substantially along the entire length of the second edge 28 of the second door panel 20 and substantially along the entire height of the door jamb 40. With reference to FIG. 8, the pivotal joints 50 can be mounted to the cladding strips 112, 122 with easily accessible fasteners as discussed above with respect to FIGS. 2 and 4.

As illustrated in FIG. 9, the second edge 28 of the second door panel 20 and the door jamb each comprise a pair of weather stripping recesses 114, 124. Weather stripping segments 116, 126 are illustrated positioned in the weather stripping recesses 114, 124. As illustrated, the weather stripping segments 116, 126 include a barbed anchor portion that extends into the weather stripping recesses 114, 124, and a compressible sealing portion that extends from the weather stripping recesses 114, 124. When, as illustrated in FIG. 9, the door system is in a closed position, adjacent compressible sealing portions of weather stripping segments 116, 126 contact each other to form a seal. As noted above, it is contemplated that other weather stripping arrangements can be used in a door system described herein to seal adjacent door panels or seal a door panel to the door jamb.

FIGS. 10-16 illustrate several other embodiments of door systems having various numbers and initial opening configurations of door panels. The pivotal connections described above of door panel-to-door panel, door panel-to-door panel-to-door jamb, and door panel-to-door jamb can be used in conjunction with various numbers of door panels to create door systems for a large variety of desired door jamb sizes. As illustrated in FIGS. 10-16, a latch connection, rather than a pivotal connection can be used between adjacent door panels or between a door panel and the adjacent door jamb to define an initial opening when the door system is opened from a closed position.

FIG. 10 illustrates a two-door panel embodiment of a door system.

FIG. 11 illustrates an alternate embodiment of three-door panel door system having an initial opening between two adjacent door panels.

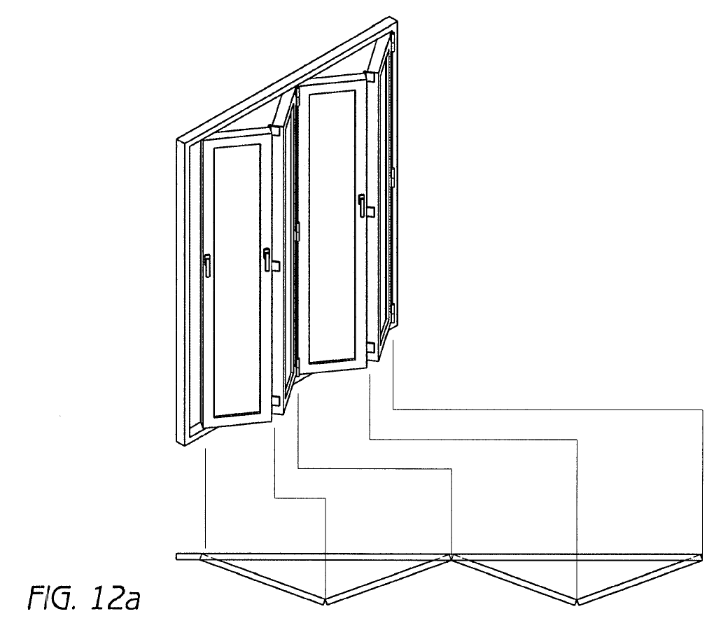

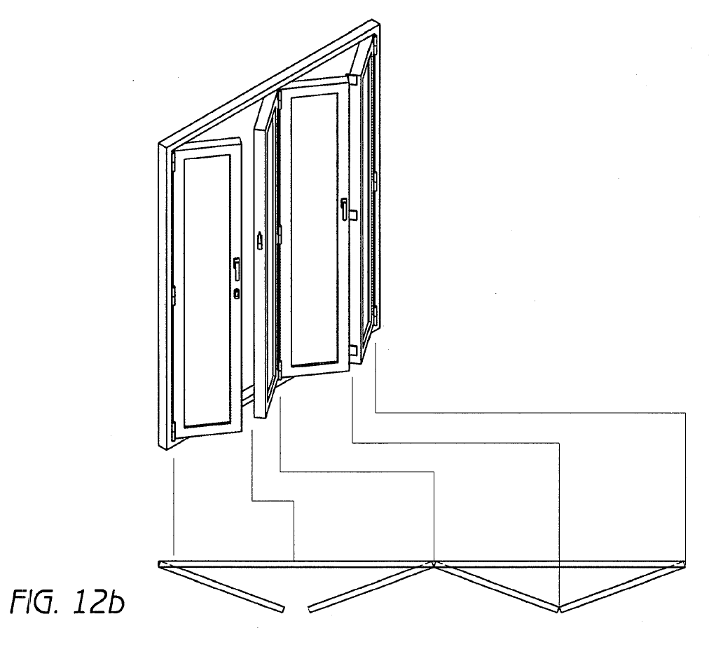

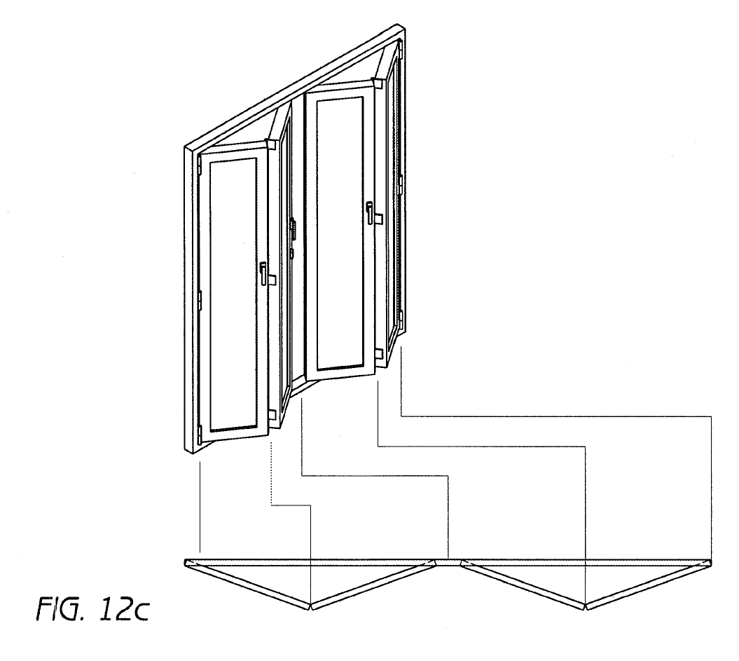

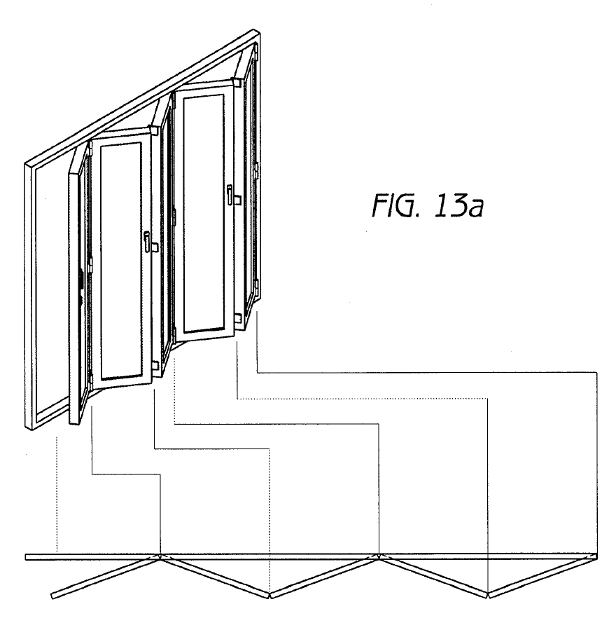

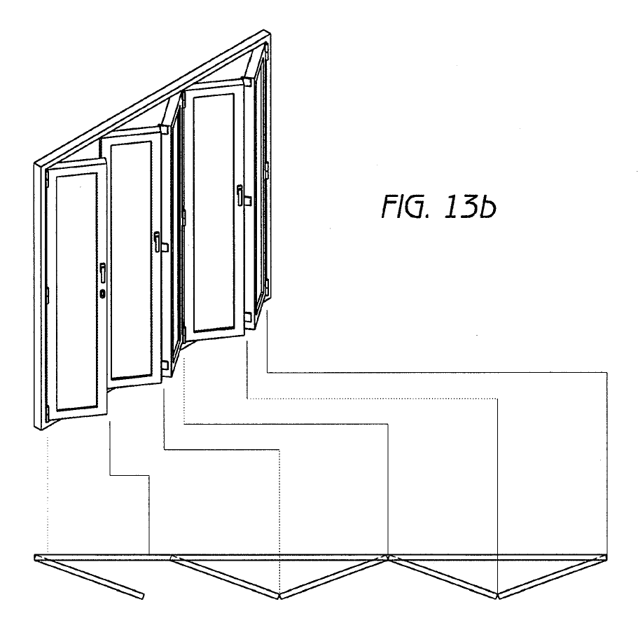

FIGS. 12a-c illustrate various embodiments of four door panel door systems having different latched connection locations and thus different initial opening locations.

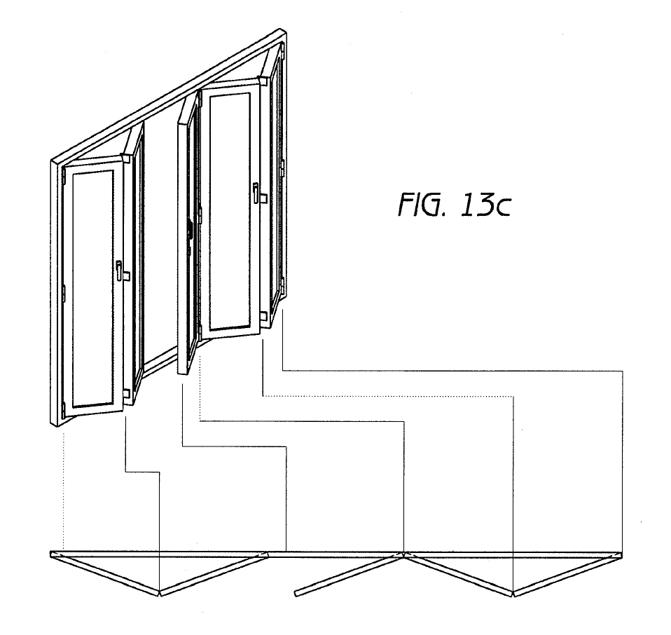

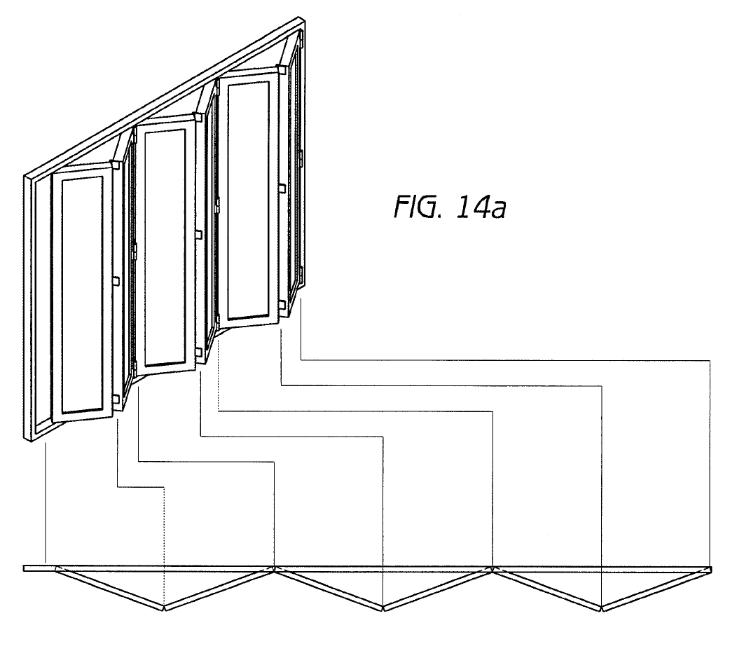

FIGS. 13a-c illustrate various embodiments of five door panel door systems having different latched connection locations and thus different initial opening locations.

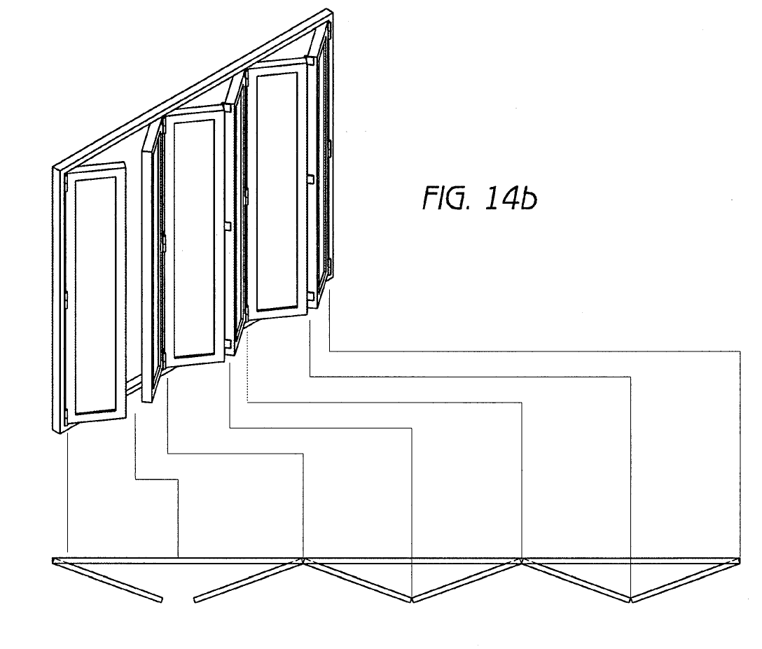

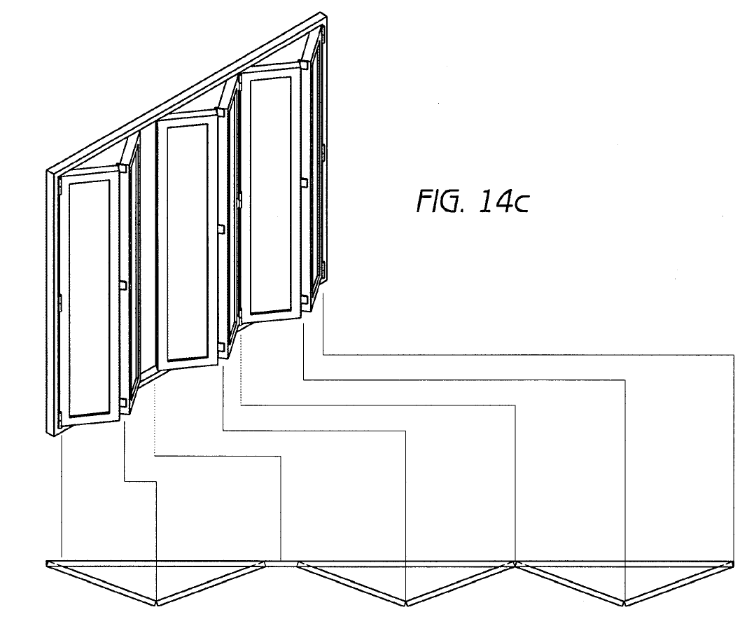

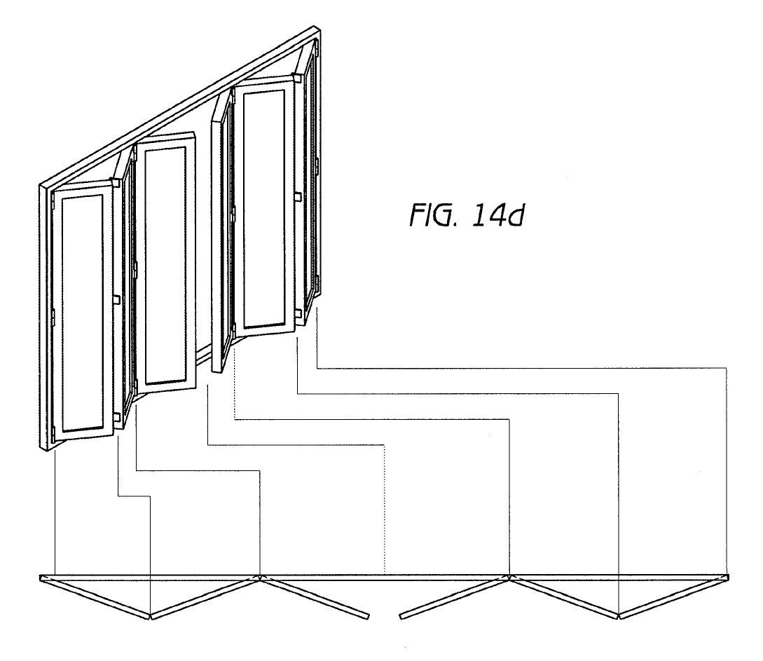

FIGS. 14a-d illustrate various embodiments of six door panel door systems having different initial opening locations.

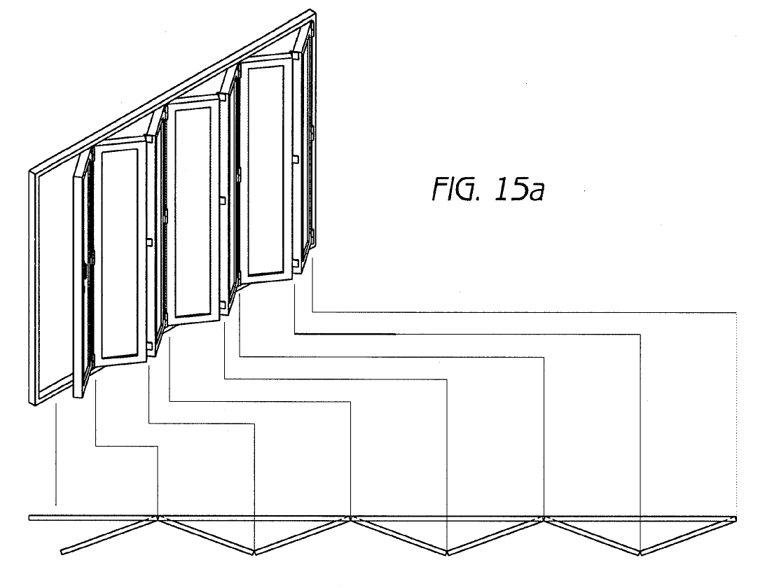

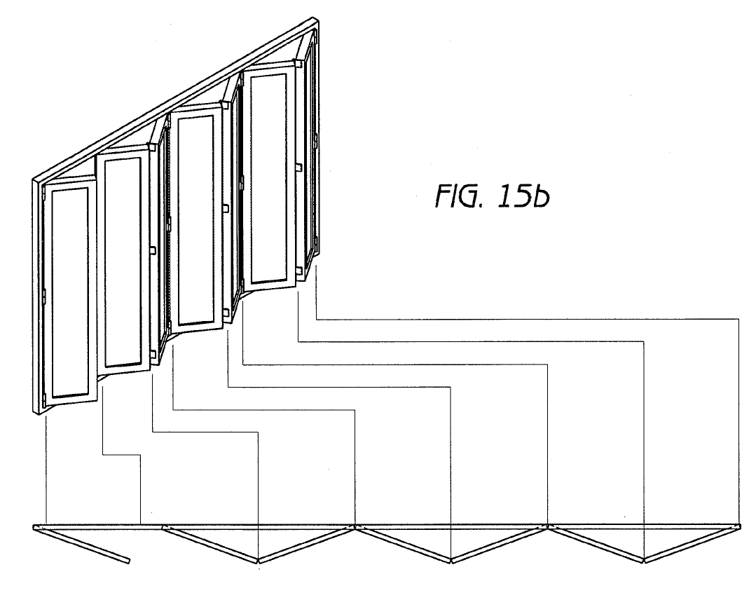

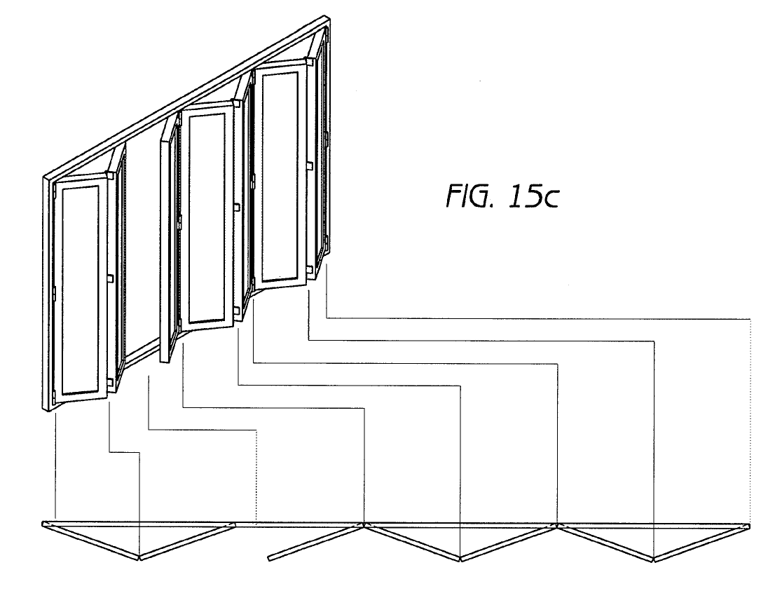

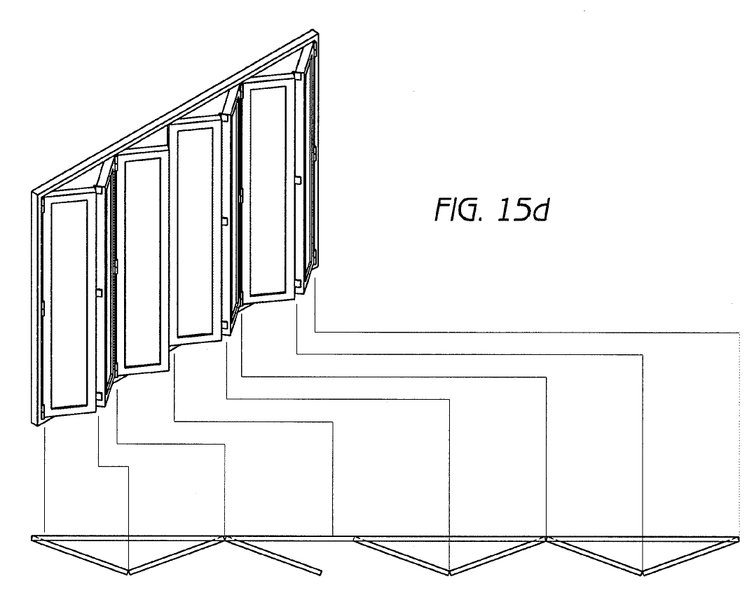

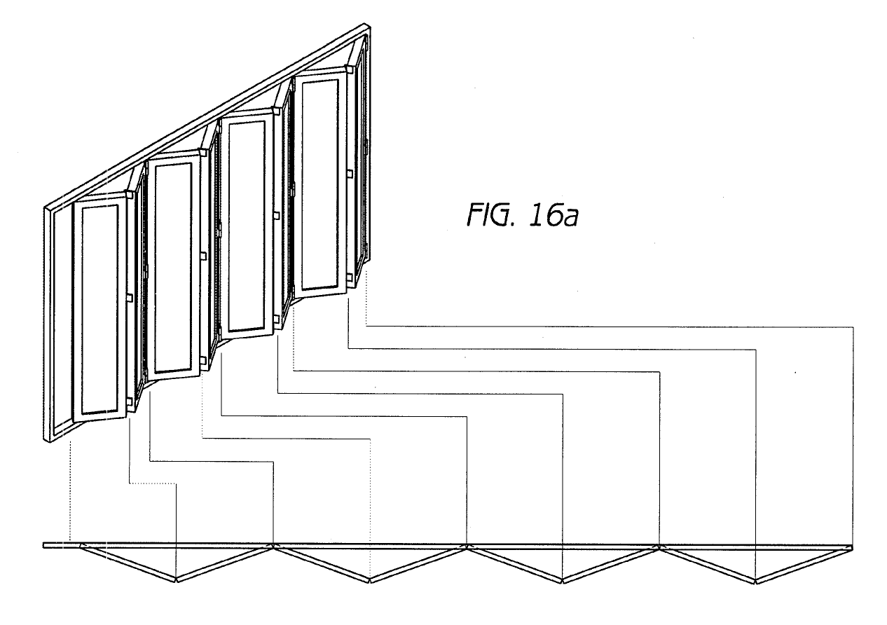

FIGS. 15a-d illustrate various embodiments of seven door panel door system having different initial opening locations.

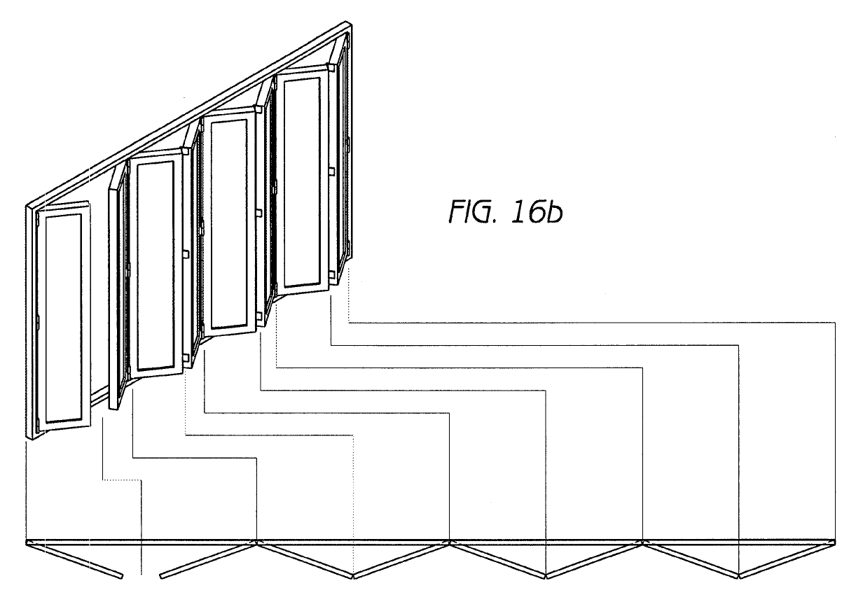

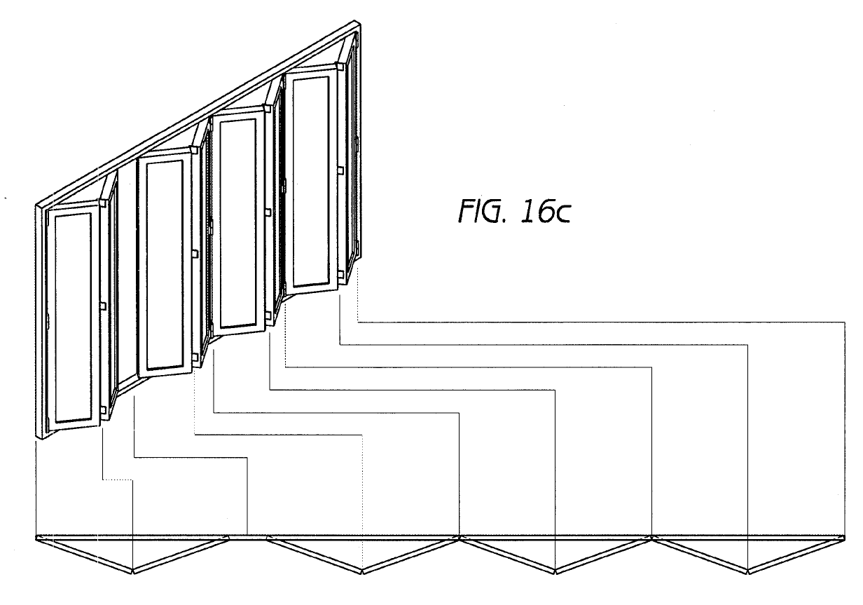

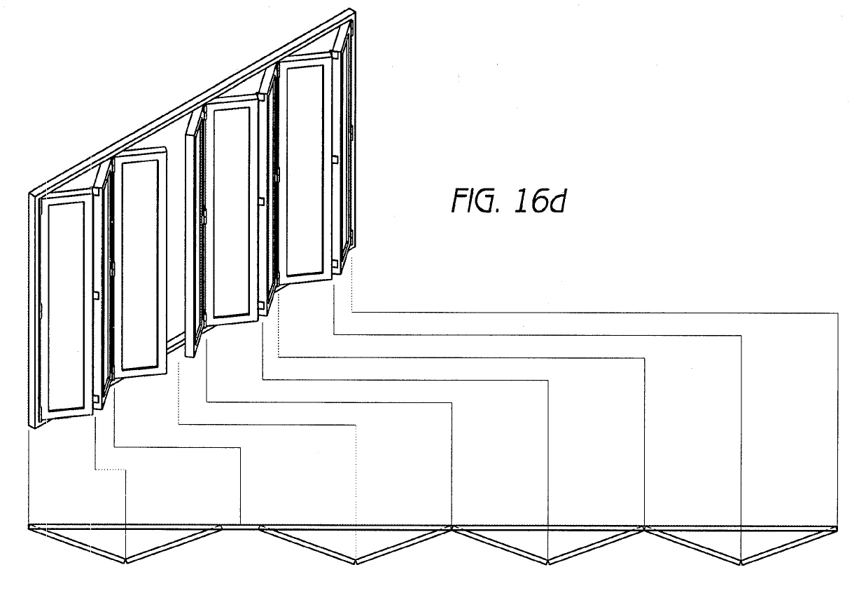

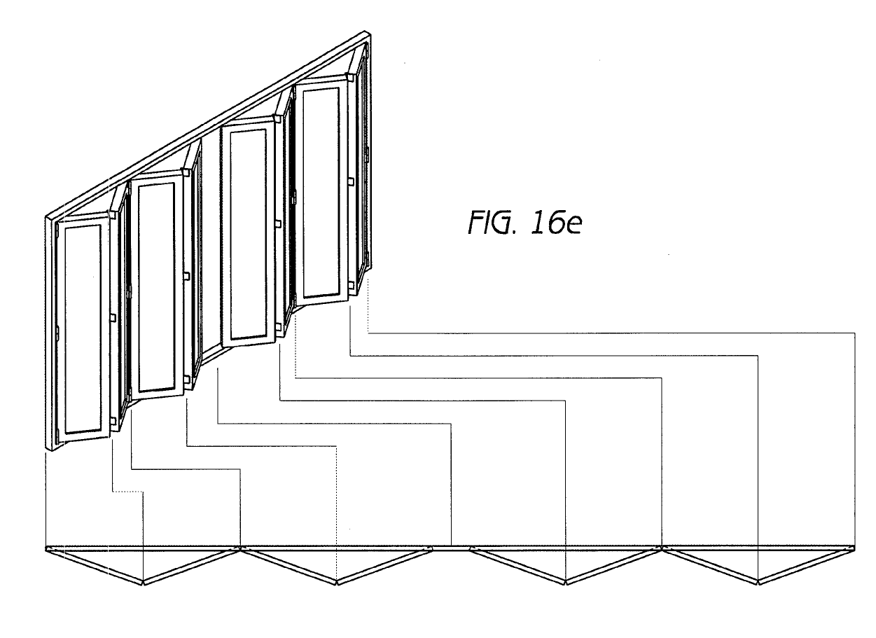

FIGS. 16a-e illustrate various embodiments of eight door panel door systems having different initial opening locations. It is contemplated that many other folding door systems can be made using the various door panel and pivotal connection configurations described herein.

It will be understood by those of skill in the art that numerous and various modifications can be made without departing from the spirit of the present invention. Therefore, it should be clearly understood that the forms of the present invention are illustrative only and are not intended to limit the scope of the present invention.

1.-29. (canceled)

30. A folding door system comprising:
a first door panel having a first door edge;
a second door panel having a second door edge;
a cladding strip spanning substantially all of the first door edge;
a pivotal joint pivotally coupling first door edge to the second door, the pivotal joint comprising:
a mount plate attached to the cladding strip;
a housing; and
an adjustable spacer slideably positionable between the mount plate and the housing,
wherein the adjustable spacer comprises a first surface, a second surface, a first mounted orientation and a second mounted orientation,
wherein the first surface abuts the housing when the housing is a first distance from the cladding strip, and
wherein the second surface abuts the housing when the housing is a second distance from the cladding strip.

31. The folding door system according to claim 30, wherein the mount plate is attached to the cladding strip with at least one screw piercing the cladding strip.

32. The folding door system according to claim 30, wherein when the adjustable spacer is in the first mounted orientation, the first distance is approximately one millimeter.

33. The folding door system according to claim 30, wherein when the spacer is in the second mounted orientation, the second distance is approximately two millimeters.

34. The folding door system of claim 30, wherein the second door panel further comprises a cladding strip spanning substantially all of the first edge of the second door panel.

35. The folding door system of claim 34, wherein the pivotal joint pivotally couples the cladding strip of the first door panel to the cladding strip of the second door panel.

36. The folding door system according to claim 30, wherein the cladding strip comprises an aluminum extrusion.

37. The folding door system according to claim 30, wherein the pivotal joint is accessibly mounted to the cladding strip.

38. The folding door system according to claim 30, wherein the pivotal joint further comprises a carriage configured to translate in a door jamb.

39. The folding door system according to claim 30, wherein one of the first door panel and the second door panel is pivotally connected to a door jamb.

40. The folding door system according to claim 30, further comprising a third door panel, wherein the third door panel is pivotally connected to one of the first door panel and the second door panel.

41. A hinge system for pivotally connecting a first door panel to an adjacent second door panel in a folding door assembly, the hinge system comprising:
a first housing comprising a first mounting portion and a first generally cylindrical portion, the first generally cylindrical portion comprising a first passage, wherein the first mounting portion is configured to be mounted to the first door panel;
a second housing comprising a second mounting portion and a second generally cylindrical portion, the second generally cylindrical portion comprising a second passage, wherein the second mounting portion is configured to be mounted to the second door panel;
a hinge pin sized and configured to pass through the first passage and the second passage, the hinge pin comprising a longitudinal axis for rotation of the first housing with respect to the second housing; and
an adjustable spacer slideably positioned between the first housing and the first door panel, the adjustable spacer configured to provide an offset therebetween;
wherein the adjustable spacer comprises a first surface, a second surface, a first mounted orientation, and a second mounted orientation,
wherein the first surface abuts the first housing when the offset is a first distance, and
wherein the second surface abuts the first housing when the offset is a second distance.

42. The hinge system of claim 41, further comprising a second adjustable spacer positioned between the second housing and the second door panel, the second adjustable spacer configured to provide a second offset therebetween.

43. The hinge system of claim 41, further comprising:
a first mount plate for mounting the first housing to the first door panel; and
a second mount plate for mounting the second housing to the second door panel.

44. The hinge system of claim 41, further comprising:
a carriage, and
a third housing pivotally coupled to the first and second housings by the hinge pin and pivotally coupled to the carriage by a carriage hinge pin such that the carriage can pivot about an axis spaced apart from an axis of rotation of the first and second housings.

45. A method of adjusting a folding door system, the method comprising:
mounting a first pivotal joint housing to an edge of a first door panel;
mounting a second pivotal joint housing to an edge of a second door panel;
connecting the first pivotal joint housing to the second pivotal joint housing such that the first door panel pivots with respect the second door panel; and
adjusting an adjustable spacer from a first offset distance to a second offset distance,
wherein the first offset distance between the first pivotal joint housing and the first door panel is greater than the second offset distance between the first pivotal joint housing and the first door panel,
wherein the adjustable spacer comprises a first surface and a second surface, the first surface abutting the first pivotal joint housing when at the first offset distance, and the second surface abutting the first pivotal joint housing in the second offset distance.

46. The method of claim 45, further comprising mounting a second adjustable spacer between the second pivotal joint housing and the second door panel.

47. The method of claim 45, wherein connecting the first door panel to the second door panel further comprises pivotally connecting the first and second pivotal joint housings with respect to each other.

48. The method of claim 45, further comprising mounting a cladding strip to the first edge of the first door panel.

49. The method of claim 48, wherein mounting a cladding strip comprises forming a recess in the first edge of the first door panel and mounting the cladding strip in the recess.
